(19) United States
(12) Patent Application Publication
(10) Pub. No.: US 2025/0037227 A1
(43) Pub. Date: Jan. 30, 2025

(54) VISUAL DATA PROCESSING IN A GRAPHICS PROCESSOR

(71) Applicant: Arm Limited, Cambridge (GB)

(72) Inventors: Damian Piotr Modrzyk, Katowice (PL); Metin Gokhan Ünal, Cambridge (GB); Giacomo Gabrielli, Cambridge (GB); Balaji Venu, Bangalore (IN)

(73) Assignee: Arm Limited, Cambridge (GB)

(21) Appl. No.: 18/777,526

(22) Filed: Jul. 18, 2024

(30) Foreign Application Priority Data
Jul. 26, 2023 (GB) 2311435.8

(51) Int. Cl. G06T 1/20; G06F 9/48

(52) U.S. Cl. CPC G06T 1/20; G06F 9/4881

(57) ABSTRACT

Provided is a graphics processing unit comprising a texture unit, an execution unit, and a machine-learning neural network engine, all configured in a pipeline in electronic communication with an integrated cache memory; and a visual data processing engine comprising a configurable stencil processor integrated into the pipeline, in electronic communication with the integrated cache memory, and configured to execute repetitive image-to-image processing instructions on visual data fetched from the integrated cache memory; wherein a graphics processing unit scheduler is configured to provide a job control function for the visual data processing engine; and wherein the visual data processing engine is configured responsively to the graphics processing unit scheduler to operate in parallel with at least one of the texture unit, the execution unit, or the machine-learning neural network engine using a separate dataflow.

The present technology is directed to the provision of graphics processing units (GPUs) configured to execute their conventional graphics processing (for example, conventional vector graphics generation and rendering) and machine learning neural network functions, and additionally configured to provide visual image data processing functions.

Conventional GPUs were designed for the specific purpose of processing inputs in the form of, typically, annotated mathematical (usually vector) representations of images, extracting geometrical forms and their positions from those representations, manipulating and interpreting annotations describing characteristics of elements in the images (such as colour and texture), and providing outputs suitable for controlling the rasterization of a final output image to display buffers ready for display on an output device, such as a display screen or a printer.

In conventional GPUs, there are units providing the various functions required for the computational processing of graphics, typically divided into execution units, texture units and post-processing units, all having access to a dedicated memory subsystem and also typically having one or more caches used for input and output buffering and for intermediate data storage during processing and usually providing high-speed data load and store operations. The units providing these functions are typically assembled into shaders, or shader cores, which are usually operable in parallel processing pipelines to handle the often very large amounts of data that need to be processed.

Because GPUs are characterised by their ability to process very large sets of data, using massive parallelism, at the very high speeds needed for detailed rendition of still or video graphics on screens, developers have observed that they are also well adapted to other uses, such as processing the very large statistical data sets needed for scientific, medical and pharmacological data analysis and for artificial intelligence inferencing.

It is thus now known in the art to use GPUs to perform other functions—for example, it is known to exploit the built-in parallel processing capabilities of GPUS to perform non-graphics-related computations, such as computations on statistical data sets or machine-learning neural network tensor data. The parallel processing capabilities of GPUs make possible the concept of the general purpose GPU (or GPGPU), operable alongside conventional CPUs to take on some workload that is in need of such parallel processing capabilities. This is typically achieved by using special purpose software that is adapted to exploit the strengths of GPU hardware for these non-graphics-related functions.

Recent developments in GPU design include new machine learning acceleration capabilities in the form of dedicated neural network engines, which may be integrated into a shader core and share the GPU memory subsystem with the other units. Such a dedicated neural network engine provides increased energy efficiency when running machine learning inference workloads, as compared with the energy consumption incurred when running the same workloads inside an execution engine.

Recently, developers have realised that it is also possible to exploit the parallel processing power of GPUs to perform visual data processing, such as image processing, by enabling texture and execution units, and, if available, any machine learning neural network engines, to perform the computations required to process the visual data, under control of specialised software. However, this approach is less than optimally efficient because the purely high-level software control of the pre-existing GPU processing units requires extra control pathways and can lead to an undesirable monopolisation of the arithmetic/logic and data path control entities in these units, and thus to an overall inefficiency in the GPU pipeline's performance.

The type of visual data processing or image processing envisioned here is the processing of input data from a camera or other image capture device to prepare the data (typically using image-to-image manipulations, such as image simplification, normalization and transformation) for computational operations such as image recognition, and this clearly differs from the conventional use of GPUS.

In an approach to addressing some difficulties in providing visual data processing in a GPU, the present technology provides a graphics processing unit according to the appended claims.

In other approaches, there may be provided a method of operating a graphics processing unit according to the present technology, and that method may be realised in the form of a computer program operable to cause a computer system to perform the process of the present technology. As will be clear to one of skill in the art, a hybrid approach may also be taken, in which hardware logic, firmware and/or software may be used in any combination to implement the present technology.

Implementations of the disclosed technology will now be described, by way of example only, with reference to the accompanying drawings, in which:

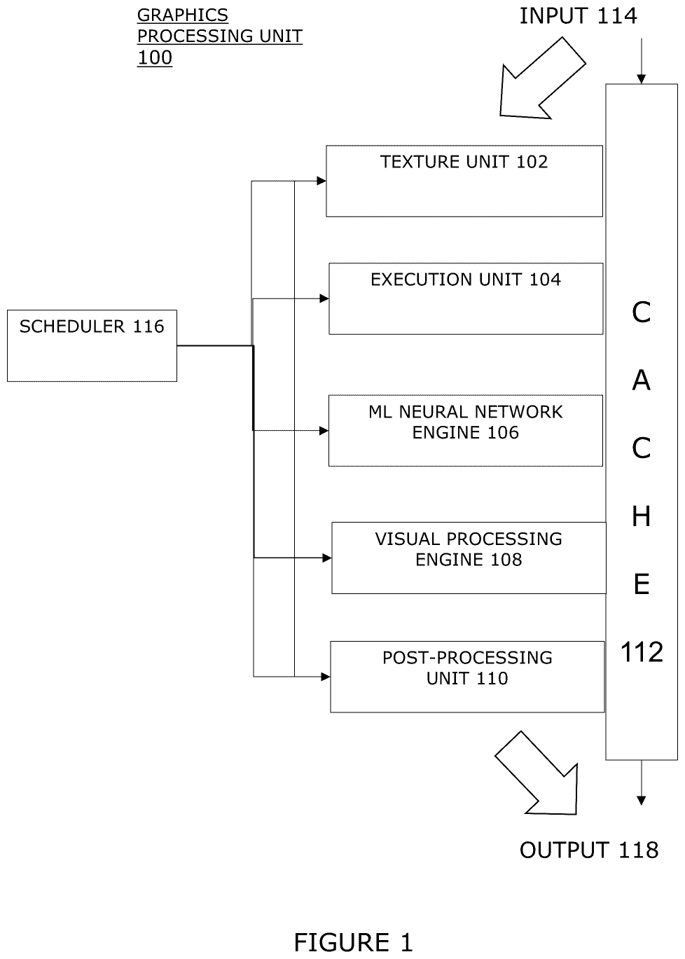

FIG. 1 shows a simplified example of a graphics processing unit according to an implementation of the present technology and comprising hardware, firmware, software or hybrid components;

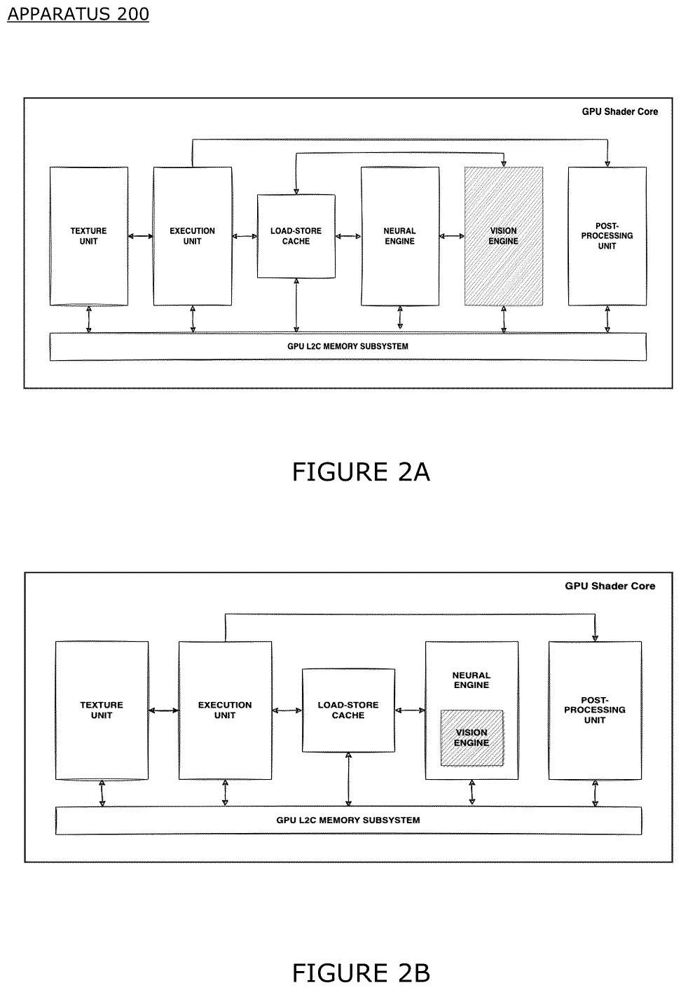

FIGS. 2A and 2B show two possible configurations of apparatus according to the present technology implemented as GPU shader cores and comprising hardware, firmware, software or hybrid components;

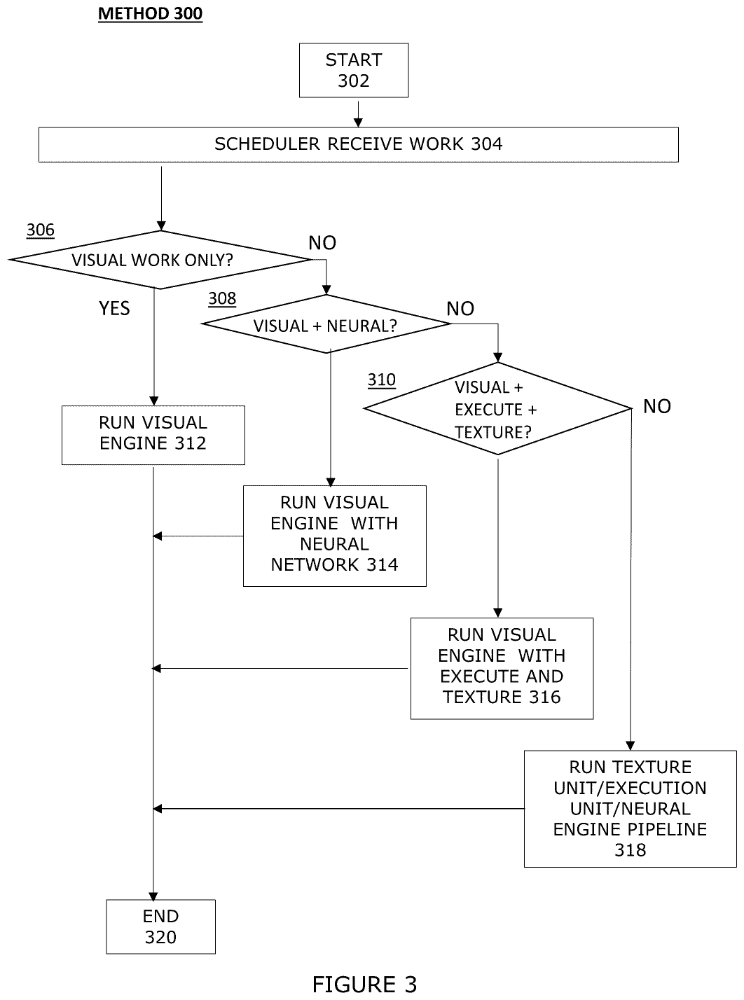

FIG. 3 shows a much simplified view of a method of operation of an apparatus or system according to the implementations of the present technology;

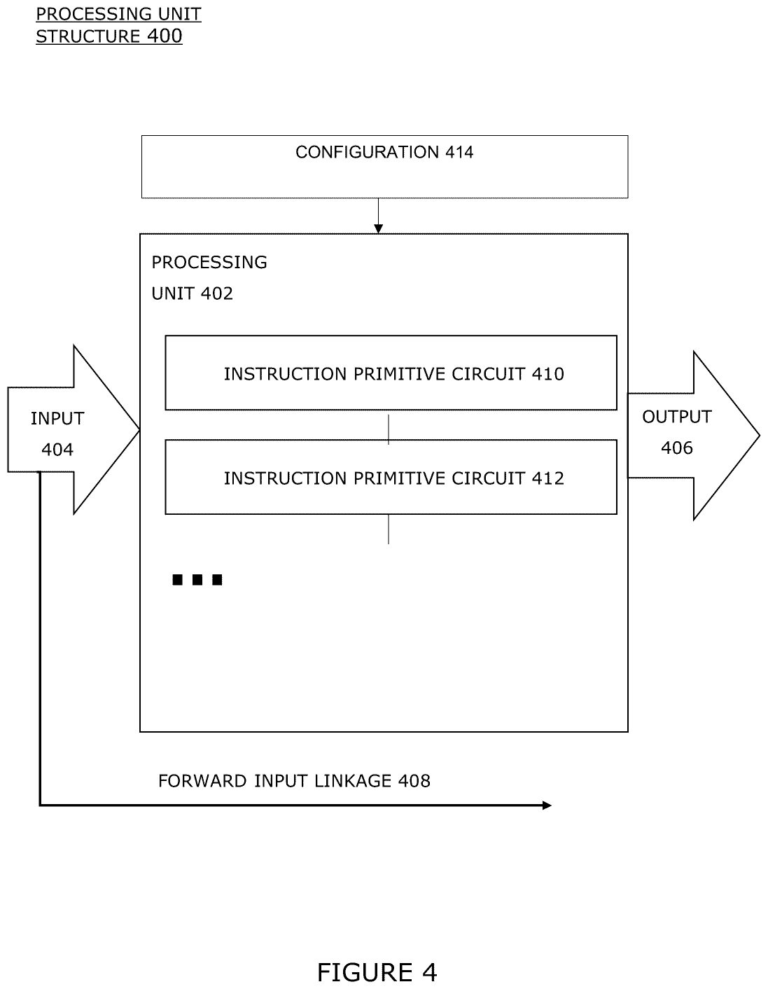

FIG. 4 shows possible structure for a processing unit according to an implementation of the present technology; and

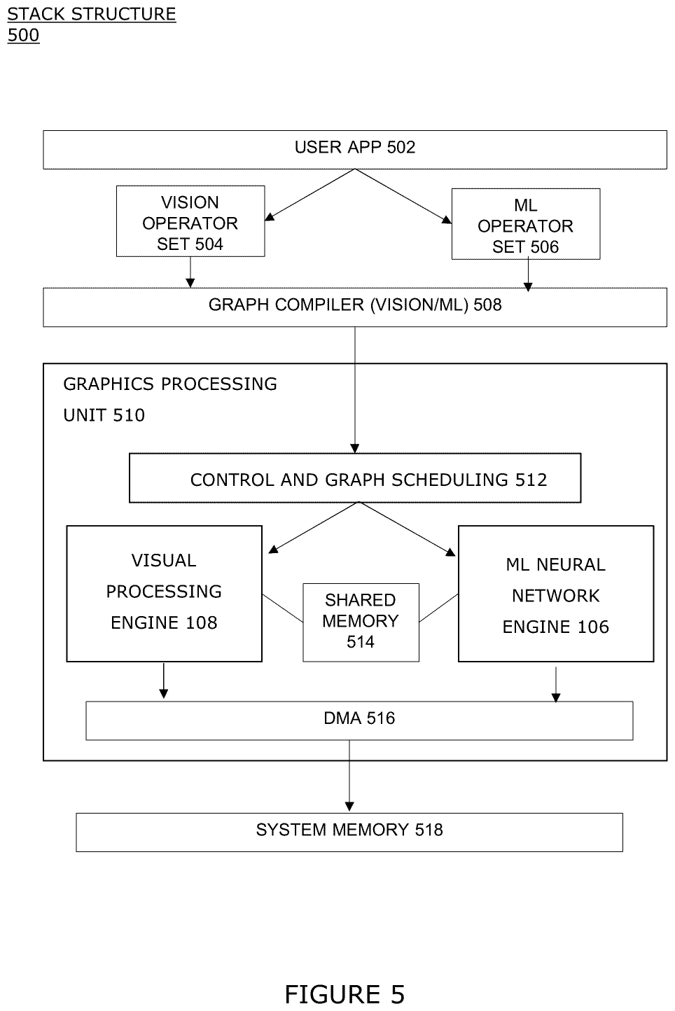

FIG. 5 shows a possible stack structure of hardware/firmware/software components according to an implementation of the present technology.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter.

Broadly, there is provided in implementations of the present technology an apparatus and a method for operating a graphics processing unit comprising a texture unit, an execution unit, and a machine-learning neural network engine, all configured in a pipeline in electronic communication with an integrated cache memory; and a visual data processing engine comprising a configurable stencil processor integrated into the pipeline, in electronic communication with the cache memory, and configured to execute repetitive image-to-image processing instructions on visual data fetched from the integrated cache memory; wherein a graphics processing unit scheduler is configured to provide a job control function for the visual data processing engine; and wherein the visual data processing engine is configured to operate in parallel with at least one of the texture unit, the execution unit, or the machine-learning neural network engine using a separate dataflow.

Implementations of the present technology are thus adapted to provide high-throughput energy-efficient visual computing or image processing.

In implementations, the graphics processing unit may have the visual data processing engine integrated into the machine-learning neural network engine. The visual data processing engine can be provided with power by a power domain separate from the power domain powering the texture unit, the execution unit, and the machine-learning neural network engine. The visual data processing engine may be operable at a processor cycle rate that is less than the processor cycle rate used for the texture unit, the execution unit, and the machine-learning neural network engine. The integrated cache memory can be configured to receive and forward visual data streamed directly from an image capture device. The visual data processing engine can be configured to supply processed image data to the machine-learning neural network engine for inferencing. The visual data processing engine can be configured to calculate and supply motion vector data for frames reconstructed using the machine-learning neural network engine. The visual data processing engine may be configured to calculate and supply motion vector data for frames reconstructed using the machine-learning neural network engine. The visual data processing engine may comprise arithmetical/logical processor units arranged in a network. The visual data processing engine can be configured to apply stencil operations to image data arranged in an n-dimensional layout.

Because of their high performance per Watt of power consumed, GPUs have become desirable computing platforms for implementing computational imaging and vision pipelines. As is known in the art, one estimate is that a GPU-implemented vision processing pipeline can result in an approximately five to ten times better performance efficiency (in performance per Watt) than a conventional CPU-based implementation. Typically, the camera, imaging, and computer vision pipelines mapped to the GPU hardware are realised by using the facilities provided by GPU shader software programs. These GPU shader software programs make use of the available GPU hardware resources, typically by using the facilities of a texture unit (TU) for hardware sampling from the image frame buffers, the facilities of an execution unit (EU) for arithmetic data paths (integer, or floating point), and the facilities of a post-processing unit (PPU) for final post-processing tasks like 2D blit (rapid data move/copy in memory) operations, composition operations like alpha compositing, colour space conversions and the like.

Thus the use of a GPU can be an effective alternative to the use of a CPU for solving complex image processing tasks. The performance per Watt of power consumed of optimized image processing solutions on a GPU is much higher than the performance of the same functions on a CPU. As will be clear to one of ordinary skill in the art, the GPU architecture allows parallel processing of image pixels which, in turn, leads to a reduction of the processing time for a single image and thus reduced latency for the system as a whole.

For image-related tasks that require the use of neural networks (such as image recognition), the provision in GPUs of hardware tensor kernels can significantly improve performance. High performance GPU software can reduce hardware resource usage in such systems, and the high energy efficiency of the GPU hardware reduces power consumption. Thus, a GPU has the flexibility, high performance, and low power consumption required to represent an attractive alternative to highly specialized field programmable gate array and application-specific integrated circuit systems, especially for mobile and embedded image processing applications. In a GPU configured in this way, visual data processing can be performed by the execution and/or texture units, or inside the neural network engine, but this typically leads to monopolisation of the arithmetical/logical capacity of these units, and hence the overall pipeline performance is degraded. In addition, software-controlled adaptation of these processing units to perform visual data processing to some extent detracts from their efficiency, as they are specifically designed for the different requirements of conventional graphics processing tasks.

The uses of computer visual processing are expanding with the developments in the use of, for example, robots and other autonomous systems requiring fast and accurate computer vision, augmented reality devices and applications, and artificial intelligence systems needing large scale learning data that may include visual representations to be provided in a usable form.

The present technology is well-adapted to provide data stream processors configured to execute repetitive or patterned arithmetical/logical operations (such as computer vision or image processing operations) on data, possibly according to stencil processing algorithms. In image processing and computer vision tasks, it is frequently necessary to perform sequences or arrangements of instructions in a patterned or correlated manner-one example of this type of processing is stencil processing.

Stencil processing operations are a widely-used type of data processing operations in which fixed patterns can be applied repetitively to subsets of sets of data (for example, using a sliding window pattern for acquiring the data to be processed), and typically involving some dependencies among the data elements of the subsets and/or correlations among the operations to be executed at each instance of the stencil's application. Stencil operations are well-adapted to take advantage of spatial and temporal locality in data, and can provide advantages in efficiency of processing and in economy of resource consumption, by, for example, reducing the number of memory accesses required to perform a process that features repetitions and correlations.

A typical example of a processing entity that is capable of performing repetitive or patterned arithmetical/logical operations on data is a Graphics Processing Unit (GPU). Conventional GPUs were designed for the specific purpose of processing inputs in the form of, typically, annotated mathematical (usually vector) representations of images, extracting geometrical forms and their positions from those representations, manipulating and interpreting annotations describing characteristics of elements in the images (such as colour and texture), and providing outputs suitable for controlling the rasterization of a final output image to display buffers ready for display on an output device, such as a display screen or a printer. In performing these functions, GPUs frequently operated in a single instruction, multiple perform repetitive arithmetical/logical operations on data.

In conventional GPUs, there are sub-units providing the various functions required for the computational processing of graphics, the sub-units having access to a dedicated memory subsystem and also typically having one or more caches used for input and output buffering and for intermediate data storage during processing and usually providing high-speed data load and store operations. The units providing these functions are typically operable in parallel processing pipelines to handle the often very large amounts of data that need to be processed.

Because GPUs are characterised by their ability to process very large sets of data, using massive parallelism, at the very high speeds needed for detailed rendition of still or video graphics on screens, developers have observed that they are also well adapted to other uses, such as processing the very large statistical data sets needed for scientific, medical and pharmacological data analysis and for artificial intelligence inferencing.

It is thus now known in the art to use GPUs to perform other functions—for example, it is known to exploit the built-in parallel processing capabilities of GPUS to perform non-graphics-related computations, such as computations on statistical data sets or machine-learning neural network tensor data. The parallel processing capabilities of GPUs make possible the concept of the general purpose GPU (or GPGPU), operable alongside conventional CPUs to take on some workload that is in need of such parallel processing capabilities. This is typically achieved by using special purpose software that is adapted to exploit the strengths of GPU hardware for these non-graphics-related functions.

Recently, developers have realised that it is also possible to exploit the parallel processing power of GPUs to perform visual data processing, such as image processing, by enabling the sub-units to perform the computations required to process the computer vision or image data, under control of specialised software.

The type of visual data processing or image processing envisioned here is the processing of input data from a camera or other image capture device to prepare the data (typically using image-to-image manipulations, such as image simplification, normalization and transformation) for computational operations such as image recognition, and this clearly differs from the conventional use of GPUS.

With the increased amount and importance of visual image computing, the present technology addresses some of the performance deficiencies encountered in known techniques of using a conventional GPU under high-level software control for classic image processing, by integrating a vision engine into a GPU shader core, where it can seamlessly interoperate with the execution units and the other graphics specific units, as well as with the neural network engine when inferencing is required, either to achieve part of the image processing task or to operate on the output of the visual processing engine as a post-process task.

In the present technology, the execution unit and the texture unit are the target blocks to handle 2D and 3D graphics rendering and the neural network engine handles artificial intelligence machine learning inference workloads, while the integrated visual processing engine (VE) is targeted for classic (non-machine learning) image, vision, and camera data processing workloads.

The integrated visual processing engine of the present technology is well adapted to perform repetitive parallel operations on image data at block and pixel levels, in particular according to the stencil processing model of operation, wherein moving n-dimensional masks of operators may be executed repetitively over large n-dimensional data sets in tensor form.

Turning to FIG. 1, there is shown a simplified example of a graphics processing unit 100 according to an implementation of the present technology and comprising hardware, firmware, software or hybrid components.

Graphics processing unit 100 comprises texture unit 102, execution unit 104 and post-processing unit 110—these units are normally responsible for the preparation of mathematical representations of graphical data for rendering one or more visual images to a display space under control of scheduler 116. Graphics processing unit 100 further comprises machine learning neural network engine 106 responsible, as broadly described above, for machine learning and inferencing tasks. All these units are operable to receive data from cache 112 and to return partially or completely processed data to cache 112, the data having been received as input 114, and to be eventually made available externally as output 118.

Additionally, in implementations of the present technology, graphics processing unit 100 comprises visual processing engine 108, broadly responsible, as described above, for classical image processing tasks under control of scheduler 116. Visual processing engine 108 is operable to receive data from cache 112 and to return partially or completely processed data to cache 112, the data having been received as input 114, and to be eventually made available externally as output 118. Visual processing engine 108 is operable to perform its processing tasks either in isolation or in cooperation with the other units in Graphics processing unit 100.

The visual processing engine 108 is operable in electronic communication with the machine learning neural network engine 106, and a load-store cache, as well as the GPU integrated cache memory subsystem (both shown for simplicity as cache 112). These interfaces allow for at least the following main data paths invoking the visual processing engine 108, depending on the use case:

1. Visual processing engine 108 “solo” operation—the visual processing engine communicates only with the GPU integrated cache subsystem in cache 112 to receive input image data and return output (processed image data).

2. Machine learning neural network engine 106 and visual processing engine 108 coordinated operation—the machine learning neural network engine 106 and visual processing engine 108 pair executes a mixed visual processing and machine learning and inferencing pipeline, wherein the input image or tensor is fetched from the GPU integrated cache subsystem in cache 112. The input is then processed either in a selected one of the two engines or in both working in parallel on different data sets. The intermediate result is passed from a neural network engine 106 to visual processing engine 108, or the reverse, to perform further processing, and the result is returned to the GPU integrated cache subsystem. In this mode visual processing engine 108 performs classic image & vision processing stages, and neural network engine 106 performs machine learning and inferencing work. Typically, some form of classic pre/post processing is required before/after the neural network engine 106 performs its machine learning and inferencing work.

3. Execution unit 104, texture unit 102 and visual processing engine 108 coordinated operation (via the load-store cache in cache 112)—in this mode graphics-specific rendering can be accompanied by acceleration of the specific visual processing tasks in the visual processing engine 108.

Turning now to FIGS. 2A and 2B, there are shown two possible configurations of apparatus according to the present technology implemented as GPU shader cores. As will be understood by those of skill in the art, these implementations may comprise hardware, firmware, software or hybrid components.

In one possible implementation as depicted in FIG. 2A, the visual processing engine 108 is arranged as a separate entity from the texture unit 102, execution unit 104, post-processing unit 110 and neural network engine 106, and is configured to be in electronic communication with at least one of those units and with cache 112 so as to accept input 114 and produce output 118 directly, or to receive input and produce output via one or more of the other units. In another possible implementation, as depicted in FIG. 2B, visual processing engine 108 is arranged as a component internal to neural network engine 106.

The visual processing engine 108 according to implementations of the present technology comprises arrangements of arithmetical/logical processor units arranged to enable parallel operation to process input data supplied in n-dimensional layouts. Typically, image data may be represented in multi-dimensional form to accommodate the 2- or 3-dimensional positional data in the image space and the attributes (such as colour, texture and the like) of the image to be rendered.

The visual processing engine 108 according to implementations of the present technology is a highly configurable processing entity which accelerates a set of common image-to-image operations, which may conform to the Vision Operator Set Architecture (VOSA) representation. The visual processing engine 108 differs from known fixed-function hardware blocks that are capable only of a limited number of simple image operations. The visual processing engine 108 is operable to accelerate image processing operations which may include, for example:
Image 1D/2D filtering (convolution);
Image resizing;
Image colour space conversions and tone mapping;
Image elementwise operations (multiply, add, subtract, min, max, compare by threshold, etc.);
Image motion vectors estimation (optical flow); etc.

The visual processing engine 108 according to implementations of the present technology is thus a programmable and flexible processing entity that may be dedicated to the energy efficient acceleration of a broad range of the common vision operations, exemplified by the list above. The visual processing engine 108 may be tuned to operate in a low voltage setting (although it is also well-adapted to operation in a high-voltage setting), and may be clocked independently of the other units, with minimum intermediate data exchange with external memory so as to ensure low power processing.

The processing units of the present technology are particularly well-adapted to perform a limited set of primitive visual processing operators from which any higher-level operators may be constructed, thereby forming a hardware/firmware/software stack implementation of a visual processing architecture arranged according to the following rules:
R1. An operator shall be a primitive operation or building block that cannot be decomposed into simpler whole visual operations;
R2. An operator shall be reusable as a component out of which more complex operations can be constructed;
R3. Precision should be appropriate for the input and output data types (as high as needed, but not wastefully higher);
R4. Numerical definition of common sub-operations should be consistent between operators (for example: image feature scaling);
R5. The valid input and output ranges for all operands shall be specified; and
R6. Integer operators shall be implementable in a bit-exact form with good efficiency. on CPU, GPU and hardware targets.

The visual processing architecture defines a set of primitive operators according to the rules to which higher level operators can be consistently reduced—the present technology provides a base upon which such an architecture can advantageously be implemented.

Each of the processing units in a compute unit according to the present technology is specifically adapted to perform data processing on at least a portion of a data stream according to the primitive operator for a received configuration instruction.

The processing architecture defines a set of primitive operators according to the rules to which higher level operators can be consistently reduced—the present technology provides a base upon which such an architecture can advantageously be implemented.

Each of the processing units in a compute unit according to the present technology is specifically adapted to perform data processing on at least a portion of a data stream according to the primitive operator or combination of operators for a received configuration instruction. There is shown in FIG. 4 a processing unit structure 400 according to implementations of the present technology. The structure comprises a configurable processing unit 402 operable in electronic communication with other entities to receive input (which may be from a wholly external entity, or may be from another peer processing unit according to the arrangement of the processing units within a compute unit). Processing unit 402 comprises an input 404, an output 406 and a forward input linkage 408, for those cases in which the input is to be received at this processing unit and also forwarded in its current state to a further processing unit 402. Processing unit 402 is arranged in electronic communication with configuration 414 (each processing unit 414 may be provided with a portion of configuration 414, in, for example, a configuration register) to accept configuration instructions that cause processing unit 402 to perform operations and to establish linkages to other entities as instructed. Processing unit 402 comprises instruction primitive circuits 410, 412 . . . that are operable to accept configuration instructions, for example to assemble themselves into higher-level instructions, and to perform operations on input data.

By providing a structure in which sets of processing units designed to perform these primitive operators can be reconfigured in various sequential and parallel structures to perform their operations on visual or image data, the present technology advantageously exploits the performance and efficiency characteristics of GPU architecture.

As will be clear to one of ordinary skill in the art, it is desirable to provide a dedicated visual processing engine 108 as an integrated element of the GPU, rather than relying on high-level software controlled adaptation of the uses of the pre-existing processing units. This enables the visual processing engine 108 to operate at its best alongside the other graphics-specific processing units, as well as the neural network engine 106 for efficient machine learning and inference acceleration. The tightly coupled integration within the GPU chassis brings benefits, such as keeping intermediate results of the image processing on chip, in the GPU integrated cache subsystem.

Because implementations of the present technology provide flexible data-paths for vision accelerated computing in the GPU, with intermediate data exchange via the GPU integrated cache subsystem, the capabilities of the GPU incorporating the present technology can be exploited in various ways. For example, where the visual processing engine 108 runs in standalone mode, other graphics and neural network units are inactive and thus the power of the GPU can be fully dedicated to the visual processing task. The power of the GPU may alternatively be split to provide parallel operation of the visual processing engine 108 with one or more of the texture unit 102, execution unit 104, post-processing unit 110 and neural network engine 106. In a further variant, visual processing engine 108 may be operated interleaved with one or more of the texture unit 102, execution unit 104, post-processing unit 110 and neural network engine 106.

Turning to FIG. 3, there is a much simplified view of a method 300 of operation of an apparatus or system according to the implementations of the present technology. The method commences at START 302, and at 304 a scheduler (for example, scheduler 116 if FIG. 1) receives a work request that comprises at least one element requiring visual processing. If, at step 306, it is determined that only visual processing work is required by the request received by the scheduler at 304, at 312 the visual processing engine 108 is invoked to run “solo” 312 to completion at END 320. END 320, as will be clear to one of skill in the art, merely represents the end of a single iteration, and the process may restart at 302 in expectation of additional work requests at 304. If at 308, it is determined that the request received by the scheduler at 304 requires visual processing work and ML neural network processing, the respective units are invoked 314 either to operate in sequence or in parallel, depending on the task parameters, to completion at END 320. If at 310, it is determined that the request received by the scheduler at 304 requires visual processing work, execution unit and texture unit processing, the respective units are invoked 316 either to operate in sequence or in parallel, depending on the task parameters, to completion at END 320. If the work request received by the scheduler at 304 is determined at 310 to require only conventional execution unit, texture unit and neural network processing, and not to require any visual data processing, the respective units are invoked 318 either to operate in sequence or in parallel, depending on the task parameters, to completion at END 320.

In this manner, implementations of the present technology can provide more energy efficient GPU-based visual computing (measured in performance per Watt of power consumed) owing to the acceleration of the most common image/vision processing operations—this efficiency can be further enhanced by way of a hardware circuit that is designed natively for stencil-based computing (and thus well adapted to the commonest tasks required for image/visual data processing). In implementations, the vision processing engine 108 microarchitecture can be optimised for this type of computing and this results in very high hardware utilisation for the arithmetic/logic blocks in the vision processing engine 108's hardware data path. This increased utilisation can translate into approximately a 10-20 times improvement in energy efficiency of visual data processing, when compared with the use of neural network engine 106, execution unit 104 and texture unit 102 blocks for visual data processing, as they are provided with functions that are particularly adapted for machine learning and inferencing and for graphics computations respectively, thus suffering some degradation in performance when used for typical tasks involved in visual data processing.

Implementations of the present technology are also operable to enable new parallel data paths in the GPU hardware when that hardware is supplemented with the visual processing engine 108. For example, the visual processing engine 108 can be used to compute high-quality motion vectors by accelerating a dense optical flow algorithm. This processing can run in parallel to the graphics rendering provided by execution unit 104 and texture unit 102, and the calculated motion vectors derived for respective tiles can be also immediately used by the neural network engine 106. The motion vectors provided by the graphics rendering engine are often too sparse (in that they may not cover all areas of the frame buffer), and hence operation of the visual processing engine 108 running motion vector estimation can help to improve image quality of the machine learning reconstructed frames for algorithms such as neural super-sampling, or neural frame rate up-sampling.

In one embodiment there is provided a stack structure 500 as shown in FIG. 5 having tightly-coupled and highly-programmable visual processing and neural network accelerator components, as well as a unified, common control and graph-oriented scheduling layer.

Stack structure 500 may comprise software, firmware and hardware elements including user applications 502 that may incorporate program operators from a vision operator set 504—instructions based on primitives specifically tailored for performing operations on visual data—and operators from a machine learning operator set 506—instructions based on primitives specifically tailored for performing operations on machine learning data, typically tensor data. The user application 502 is processed at least in part by the graph compiler 508, which is adapted to compile both vision operators from 504 and machine learning operators from 506 into a unified program processing graph. Graph compiler 508 is arranged in at least intermittent electronic communication with graphics processing unit 510 to provide compiled graph data to control and graph scheduling component 512, which controls and schedules the activities of visual processing engine 108 and machine learning (ML) neural network engine 106. Visual processing engine 108 and machine learning (ML) neural network engine 106 are operable to make use of shared memory 514 (which may comprise on-chip SRAM memory resources) for local memory operations, and to provide data as required via DMA component 516 to system memory 518.

There is thus provided in this embodiment a single centralised point of control in the control and graph scheduling component 512 which fetches the command stream for the visual processing engine 108 and the ML neural network 106 and controls overall processing and data-flow for the compute stages, as defined by the output of the graph compiler.

Graph-based programming (software) model for both ML and non-ML parts of the vision pipeline, thanks to Vision Processor Graph Compiler incorporating graph-based vision pipeline abstractions leveraging specifically-designed visual processing instruction set architecture and a specifically-designed machine learning tensor-based instruction set intermediate representations.

In this way, the present technology may achieve improved energy efficiency by way of end-to-end visual and machine-learning pipeline scheduling optimised for keeping data on-chip and maximizing utilisation of available hardware resources. This efficiency may combine with improved performance by also avoiding Remote Procedure Calls (RPC) between the host CPU and the visual processing engine. The present technology may further benefit from a reduction in chip area due to increased sharing of the hardware resources in the form of common control, SRAM and DMA resources.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed.

The present technology further provides processor control code to implement the above-described systems and methods, for example on a general purpose computer system or on a digital signal processor (DSP).

As will be appreciated by one skilled in the art, the present techniques may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product tangibly embodied in a non-transitory computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

1. A graphics processing unit comprising:
an execution unit and a machine-learning neural network engine, both configured in a pipeline in electronic communication with an integrated cache memory; and
a visual data processing engine comprising a configurable stencil processor integrated into the pipeline, in electronic communication with the integrated cache memory, and configured to execute image processing instructions on visual data fetched from the integrated cache memory;
wherein a graphics processing unit scheduler is configured to provide a job control function for the visual data processing engine; and
wherein an instance of the visual data processing engine is configured responsively to the graphics processing unit scheduler to operate in parallel with the execution unit or the machine-learning neural network engine using a separate dataflow.

2. The graphics processing unit according to claim 1, wherein an instance of the visual data processing engine is configured responsively to the graphics processing unit scheduler to operate in sequence with the execution unit or the machine-learning neural network engine using the same dataflow.

3. The graphics processing unit according to claim 1, wherein the visual data processing engine is integrated into an instance of the machine-learning neural network engine.

4. The graphics processing unit according to claim 1, wherein the visual data processing engine is provided with power by a power domain separate from the power domain powering the texture unit, the execution unit, and the machine-learning neural network engine.

5. The graphics processing unit according to claim 1, wherein the visual data processing engine is operable at a processor cycle rate that is less than the processor cycle rate used for the texture unit, the execution unit, and the machine-learning neural network engine.

6. The graphics processing unit according to claim 1, wherein the integrated cache memory is configured to receive and forward visual data streamed directly from an image capture device.

7. The graphics processing unit according to claim 1, wherein the visual data processing engine is configured to supply processed image data to the machine-learning neural network engine for inferencing.

8. The graphics processing unit according to claim 1, wherein the visual data processing engine is configured to calculate and supply motion vector data for frames reconstructed using the machine-learning neural network engine.

9. The graphics processing unit according to claim 1, wherein the visual data processing engine is configured to calculate and supply motion vector data for frames filtered using the machine-learning neural network engine.

10. The graphics processing unit according to claim 1, wherein the visual data processing engine is configured to calculate and supply motion vector data for frames densified using the machine-learning neural network engine.

11. The graphics processing unit according to claim 1, wherein the visual data processing engine comprises arithmetical/logical processor units arranged in a network.

12. The graphics processing unit according to claim 1, wherein the visual data processing engine is configured to apply stencil operations to image data arranged in an n-dimensional layout.

13. The graphics processing unit according to claim 1, wherein the visual data processing engine and the machine-learning neural network engine are operable under common control by a single scheduler.

14. A method of operating a graphics processing unit, comprising:
receiving a graphics processing unit work request to process data;
distinguishing a request requiring visual data processing from requests requiring only processing by an execution unit and/or a neural network unit;
retrieving data from an integrated cache memory of the graphics processing unit;
scheduling work in the graphics processing unit according to the request to perform visual data processing in parallel with, and independently of, other graphics processing unit operations;
wherein performing visual data processing comprises executing image processing instructions.

15. The method according to claim 14, wherein executing repetitive image-to-image processing instructions comprises stencil processing.

16. The method according to claim 14, wherein retrieving data from an integrated cache memory of the graphics processing unit comprises retrieving visual data streamed directly from an image capture device.

17. The method according to claim 14, further comprising supplying processed image data to a machine-learning neural network engine for inferencing.

18. The method according to claim 14, further comprising calculating and supplying motion vector data for frames reconstructed using a machine-learning neural network engine.

19. A computer program comprising computer program code to, when loaded Into a computer and executed thereon, cause the computer to perform the steps of the method according to claim 14.
